(19) United States
(12) Patent Application Publication
(10) Pub. No.: US 2007/0174722 A1
(43) Pub. Date: Jul. 26, 2007

(54) Input/output control method, computer product, and disk control apparatus

(75) Inventors: Seiji Toda, Kawasaki (JP); Mitsuhiko Ohta, Kawasaki (JP); Arata Ejiri, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/384,839

(22) Filed: Mar. 20, 2006

(30) Foreign Application Priority Data
Dec. 13, 2005 (JP) 2005-359476

(51) Int. Cl. G06F 11/00

(52) U.S. Cl. 714/42

(57) ABSTRACT

In a device control apparatus, a state judging unit, to which an I/O request received by an I/O request receiving unit is passed, acquires a device state by issuing a state check command to a control command queue of a magnetic disk device. When the device state acquired is normal, an I/O requesting unit issues an I/O command to an I/O command queue of the magnetic disk device. When the device state acquired is not normal, an I/O response notifying unit notifies a request source of the I/O request of error information of the device state.

### BACKGROUND OF THE INVENTION

1. Field of the Invention

The present invention relates to a technology for detecting an error made by a magnetic disk device at an early stage.

2. Description of the Related Art

Magnetic disk devices are widely used to store data. However, input/output errors can occur in the magnetic disk devices due to a physical damage, vibration, or faulty parts.

When an error occurs, an attempt is made to recovery the data from the magnetic disk device by, for example, reissuing an input/output command to the magnetic disk device. However, because it is common to process the input/output commands based on timeout/retry (reissuance), the recovery process takes a considerable time. An operating system of a computer that employs the error magnetic disk device, or application programs operating on the operating system, are forced to wait until the time-taking recovery process is completed.

Various techniques are know that take care of this issue. For example, Japanese Patent Application Laid-Open No. H06-051914 discloses counting the number of failures occurring in a magnetic disk device and closing the magnetic disk device if the number exceeds a predetermined value. Japanese Patent Application Laid-Open No. 2003-233540 discloses a technology for grasping a retry state concerning disk I/O with a predetermined processing unit.

However, the conventional techniques can take care of only non-fatal (recoverable) errors. In other words, the conventional techniques are of no use when a fatal (unrecoverable) error has occurred.

In recent years, the need to store a large amount of data has increased. To store a large amount of data, storage devices, such as disk array apparatus, having a large number of magnetic disk devices are employed. When an error occurs in one magnetic disk device, that magnetic disk device is closed, and instead a substitute magnetic disk device is used. However, unless a faulty magnetic disk device is detected in short time, the data recovery process takes longer time.

Therefore, there is need for a technology to detect an error in a magnetic disk device fast.

### SUMMARY OF THE INVENTION

It is an object of the present invention to at least solve the problems in the conventional technology.

According to an aspect of the present invention, an input/output control method for a magnetic disk device that includes a data command queue of data input/output commands and a control command queue of control commands, includes issuing an inquiry command to the control command queue; receiving state information indicative of a state of the magnetic disk device in response to the inquiry command; judging whether the magnetic disk device is in a normal state based on the state information; issuing a data input/output command to the data command queue when it is judged at the judging that the magnetic disk device is in the normal state; and outputting error information indicative of a faulty magnetic disk device when it is judged at the judging that the magnetic disk device is not in the normal state.

According to another aspect of the present invention, an input/output control method for a magnetic disk device that includes a data command queue of data input/output commands and a control command queue of control commands, including data command issuing including issuing a data input/output command to the data input/output command queue; inquiry command issuing including issuing an inquiry command at a predetermined interval from issuance of the data input/output command at the data command issuing; receiving state information indicative of a state of the magnetic disk device in response to each of the inquiry command issued at the inquiry command issuing; judging whether the magnetic disk device is in a normal state based on each of the state information received at the receiving; and outputting error information indicative of a faulty magnetic disk device when it is judged at the judging that the magnetic disk device is not in the normal state.

According to still another aspect of the present invention, a disk control apparatus for performing input/output control on a magnetic disk device that includes a data command queue of data input/output commands and a control command queue of control commands, includes a receiving unit that issues an inquiry command to the control command queue and receives state information indicative of a state of the magnetic disk device in response to the inquiry command; a judging unit that judging whether the magnetic disk device is in a normal state based on the state information received by the receiving unit; an issuing unit that issues a data input/output command to the data command queue when it is judged by the judging unit that the magnetic disk device is in the normal state; and an outputting unit that outputting error information indicative of a faulty magnetic disk device when it is judged by the judging unit that the magnetic disk device is not in the normal state.

According to still another aspect of the present invention, a computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining an input/output control method according to an embodiment of the present invention;

FIG. 2 is a block diagram of a disk control apparatus according to an embodiment of the present invention;

FIG. 3 is a flowchart of a processing procedure performed by the disk control apparatus shown in FIG. 2;

FIG. 4 is a flowchart of a modification of the processing procedure performed by the disk control apparatus shown in FIG. 2;

FIG. 5 is a block diagram of a disk control apparatus according to another embodiment of the present invention;

FIG. 6 is a flowchart of a processing state response processing;

FIG. 7 is a block diagram of a driver and a magnetic disk device according to an embodiment of the present invention;

FIG. 8 is a block diagram of a disk control apparatus according to still another embodiment of the present invention; and

FIG. 9 is a flowchart of a substitution processing.

### DETAILED DESCRIPTION OF THE PREFERRED EMBODIMENTS

Exemplary embodiments of the present invention are explained in detail below with reference to the accompanying drawings.

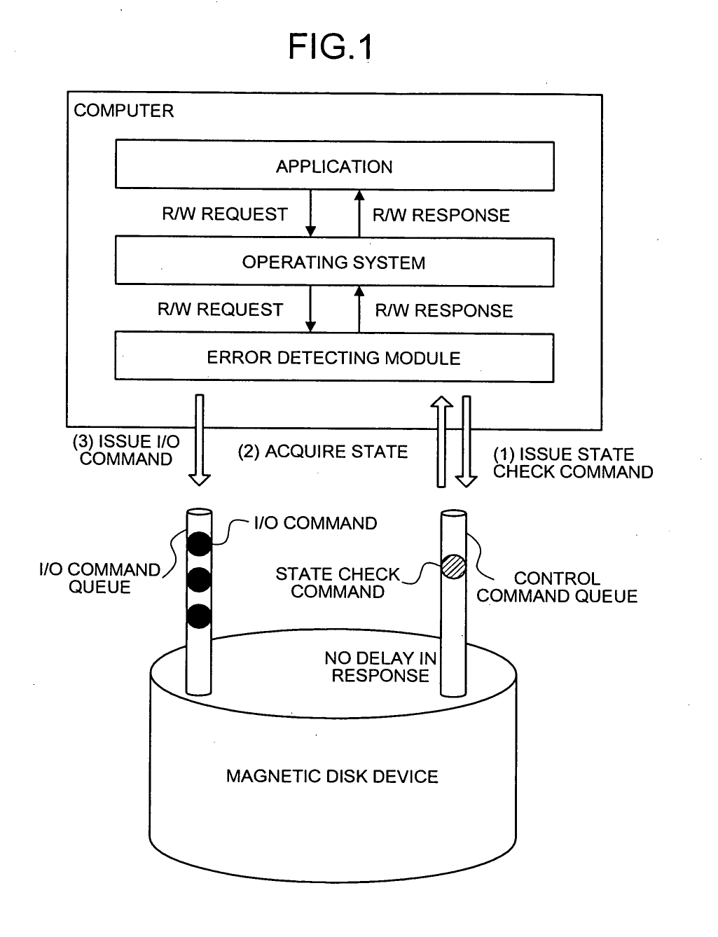

FIG. 1 is a schematic diagram of an input/output control method according to an embodiment of the present invention. According to the embodiment, an error detecting module is functionally provided between an operating system and a magnetic disk device. The error detecting module relays a read/write (R/W) request and, after checking a device state of the magnetic disk device using a control command queue of the magnetic disk device, issues an input/output (I/O) command to the magnetic disk device.

A case has been shown in FIG. 1 in which error detecting module is provided in a computer on which an operating system operating. However, the error detecting module can be provided in a magnetic disk device, or an input/output control device including an error detecting module may be separately provided.

As shown in FIG. 1, an R/W request issued by an application program (hereinafter, “application”) is passed to the error detecting module via the operating system. The error detecting module issues a state check command to the control command queue of the magnetic disk device (see (1) in FIG. 1).

The control command queue and the I/O command queue are queues generally provided in almost any existing magnetic disk device. The control command queue and the I/O command queue are realized by firmware operating on the magnetic disk device or by an electronic circuit.

The I/O command queue is a queue that is used by the magnetic disk device to receive a write request (an INPUT command) and a readout request (an OUTPUT command). The magnetic disk device executes an input/output operation for a medium (a disk) by sequentially processing I/O commands stored in the I/O command queue and outputs a response corresponding to each of the I/O commands.

If there are a large number of I/O commands, it takes time to output the response. Conventionally, when there is an unexpected delay in the response, it is judged that a R/W request has failed, and the R/W request is reissued.

However, a fatal error in the magnetic disk device can be detected only after repeatedly issuing an I/O command. During that time, the operating system and the application are forced to wait.

On the other hand, the control command queue is a queue of control commands defined by standards such as AT attachment (ATA) and Small Computer System Interface (SCSI). A control command stored in the control command queue is executed in a shorter time than receiving individual I/O command separately. The control command includes a command for acquiring a device state of the magnetic disk device.

On the contrary, according to the present embodiment, the error detecting module is constituted to issue a command for acquiring a device state of the magnetic disk device to the control command queue (see (1) in FIG. 1), acquire a device state of the magnetic disk device (see (2) in FIG. 1), and, after checking that the device state is normal, issue an I/O command (see (3) in FIG. 1). When the error detecting module decides that the device is in abnormal state, the error-detecting module informs the operating system that the magnetic disk device is in abnormal state.

As a result, the operating system and the application can recognize whether there is a fatal error in the magnetic disk device at an early stage so that the operating system and the application need not wait.

In the input/output control method according to the present invention, a device state of the magnetic disk device is acquired using control commands defined by the standards such as ATA and SCSI. Thus, even when a general magnetic disk device is used, it is possible to detect abnormality of the magnetic disk device at an early stage.

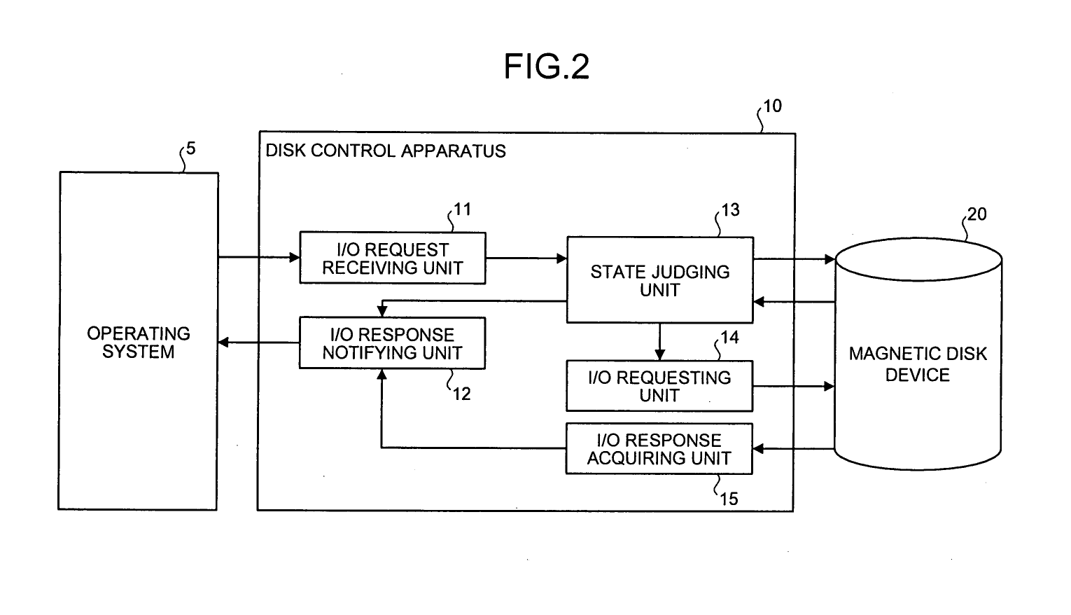

A disk control apparatus that implements the input/output control method is explained with reference to FIG. 2. A disk control apparatus 10, which includes the error detecting module shown in FIG. 1, is functionally arranged between an operating system 5 and a magnetic disk device 20.

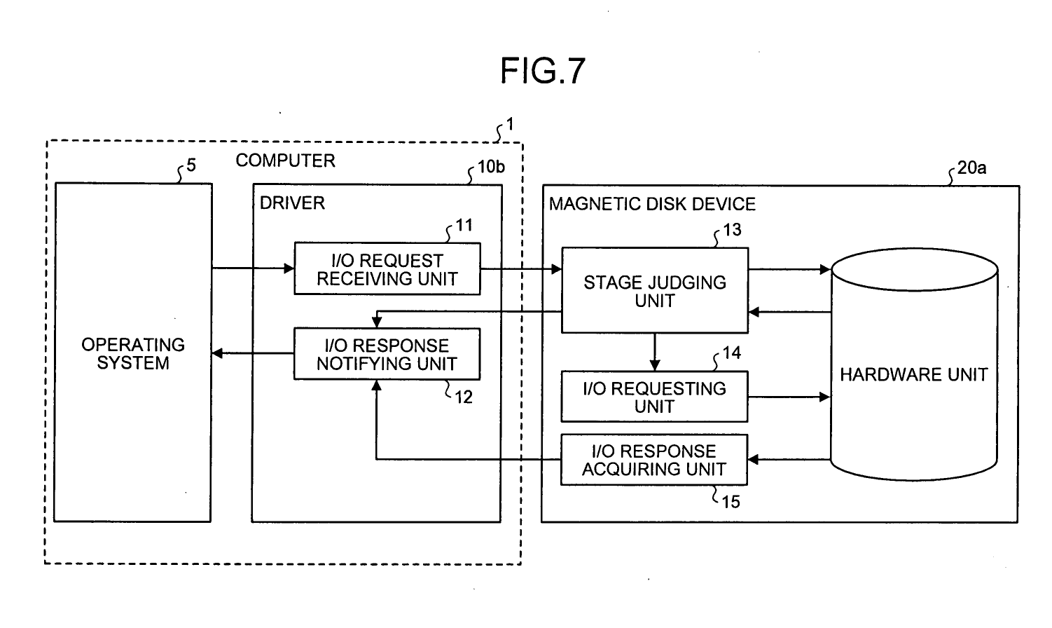

However, the present invention is not limited to this constitution. It is also possible to provide a function equivalent to that of the disk control apparatus 10 on a computer on which the operating system 5 operates or on the magnetic disk device 20. Such a modification is explained below with reference to FIG. 7.

As shown in FIG. 2, the disk control apparatus 10 includes an I/O request receiving unit 11, an I/O response notifying unit 12, a state judging unit 13, an I/O requesting unit 14, and an I/O response acquiring unit 15. The respective processing units are realized by a computer program, such as firmware, operating on the disk control apparatus 10. The respective processing units can be constituted using electronic circuits.

The I/O request receiving unit 11 performs processing for receiving requests like a write request and a readout request from the operating system 5 and passing the requests received to the state judging unit 13. The I/O response notifying unit 12 performs processing for notifying the operating system 5 of a device state or an I/O response passed from the state judging unit 13 or the I/O response acquiring unit 15.

In this way, the operating system 5 sends an I/O request to the I/O request receiving-unit 11 serving as an interface section and receives an I/O response from the I/O response notifying unit 12. Thus, the operating system 5 only has to perform usual I/O processing without being conscious of other processing executed in the disk control apparatus 10. A device state of the magnetic disk device 20 is included in the I/O response when the device state is notified to the operating system 5.

The state judging unit 13 is a processing unit that issues, when the I/O request is received from the I/O request receiving unit 11, a device state inquiry command to a control command queue (see FIG. 1) of the magnetic disk device 20 to acquire a device state and gives a predetermined instruction to the I/O response notifying unit 12 or the I/O requesting unit 14 based on the device state acquired.

Specifically, when the acquired device state is normal, the state judging unit 13 instructs the I/O requesting unit 14 to issue the I/O request received from the I/O request receiving unit 11 to the magnetic disk device 20. On the other hand, when the acquired device state is abnormal, the state judging unit 13 instructs the I/O response notifying unit 12 to notify the operating system 5 that the magnetic disk device 20 is abnormal.

The state judging unit 13 can also repeat the issuance of the device state inquiry command to the magnetic disk device 20 for a plurality of times at each predetermined interval. As described above, the device state inquiry command issued to the control command queue is processed by the magnetic disk device 20 without delay. However, when a temporary failure (a recoverable failure) occurs in the magnetic disk device 20, the magnetic disk device 20 may fail in response to the device state inquiry command issued once. Therefore, if the device state inquiry command is issued a plurality of times, it is possible to distinguish such a temporary failure and a serious failure (an unrecoverable failure) from each other and notify the operating system 5 of the failures.

The I/O requesting unit 14 is a processing unit that performs processing for issuing the I/O request received by the I/O request receiving unit 11 to an I/O command queue (see FIG. 1) of the magnetic disk device 20 according to an instruction of the state judging unit 13. The I/O response acquiring unit 15 is a processing unit that performs processing for relaying the I/O response received from the magnetic disk device 20 to the I/O response notifying unit 12.

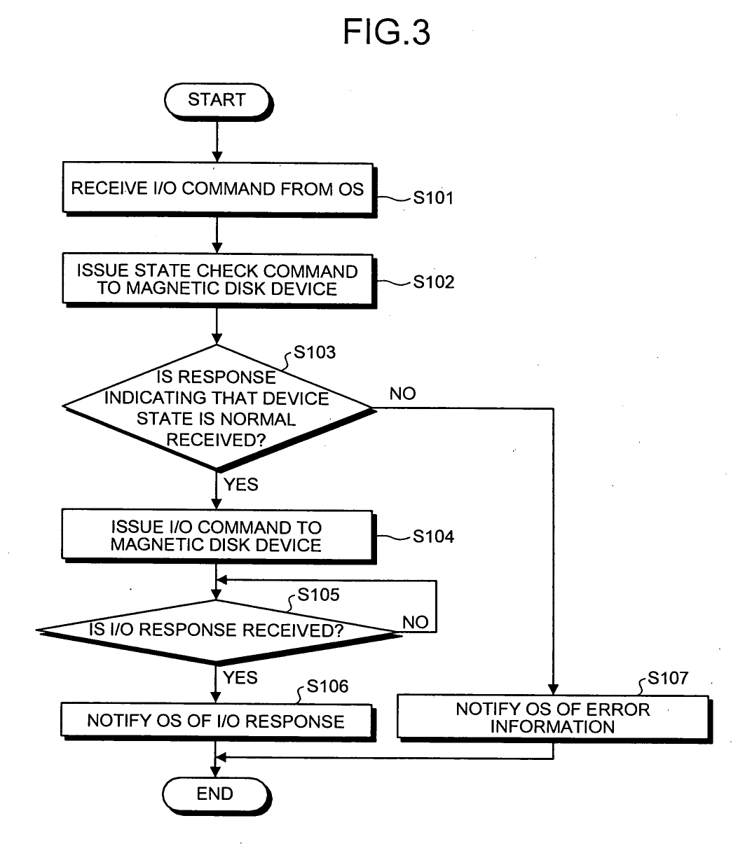

A processing procedure in the disk control apparatus 10 shown in FIG. 2 is explained with reference to FIG. 3. FIG. 3 is a flowchart of the processing procedure in the disk control apparatus 10. As shown in the figure, when the I/O request receiving unit 11 receives an I/O request (an I/O command) from the operating system (hereinafter, “OS”) 5 (step S101), the state judging unit 13 issues a state check command to the control command queue of the magnetic disk device 20 (step S102).

When the state judging unit 13 receives a response indicating that a device state is normal from the magnetic disk device 20 (“Yes” at step S103), the I/O requesting unit 14 issues an I/O command to the I/O command queue of the magnetic disk device 20 (step S104). On the other hand, when the state judging unit 13 does not receive a response indicating that a device state is normal from the magnetic disk device 20 (“No” at step S103), that is, when the state judging unit 13 receives a response indicating that a device state is abnormal or does not receive a response within a predetermined time, the I/O response notifying unit 12 notifies the OS 5 of error information (step S107). The disk control apparatus 10 ends the processing.

Following the processing at step S104, when the I/O response acquiring unit 15 receives an I/O request response from the magnetic disk device 20 (“Yes” at step S105), the I/O response notifying unit 12 notifies the OS 5 of an I/O response (step S106). The disk control apparatus 10 ends the processing. On the other hand, when the I/O response acquiring unit 15 does not receive an I/O response (“No” at step S105), the I/O response acquiring unit 15 repeats the processing at step S105 until the I/O response acquiring unit 15 receives an I/O response.

As shown in FIG. 3, the disk control apparatus 10 acquires a device state of the magnetic disk device 20 by issuing a state check command prior to the issuance of an I/O command and issues an I/O command on condition that the device state is normal. Therefore, it is possible to detect abnormality of the magnetic disk device 20 at an early stage. It is also possible to prevent a situation in which the disk control apparatus 10 issues an I/O command to the magnetic disk device 20 falling into an unrecoverable failure and causes the OS 5 to wait for a long time.

In the flowchart shown in FIG. 3, an I/O command is issued after normality of the magnetic disk device 20 is checked according to a state check command. However, a serious failure could occur in the magnetic disk device 20 after the disk control apparatus 10 issues an I/O command. Thus, a processing procedure capable of detecting even a failure after issuance of an I/O command is explained below.

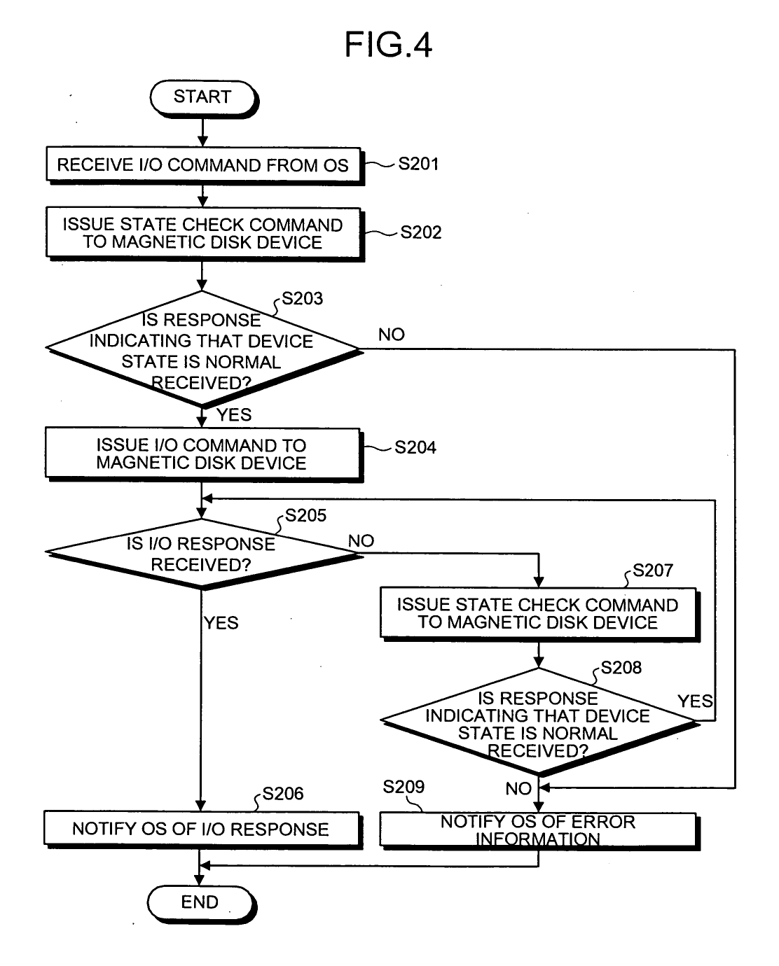

FIG. 4 is a flowchart of a modification of the processing procedure in the disk control apparatus 10. As shown in the figure, when the I/O request receiving unit 11 receives an I/O request (an I/O command) from the OS 5 (step S201), the state judging unit 13 issues a state check command to the control command queue of the magnetic disk device 20 (step S202).

When the state judging unit 13 receives a response indicating that a device state is normal from the magnetic disk device 20 (“Yes” at step S203), the I/O requesting unit 14 issues an I/O command to the I/O command queue of the magnetic disk device 20 (step S204). On the other hand, when the state judging unit 13 does not receive a response indicating that a device state is normal from the magnetic disk device 20 (“No” at step S203), that is, when the state judging unit 13 receives a response indicating that a device state is abnormal or does not receive a response within a predetermined time, the I/O response notifying unit 12 notifies the OS 5 of error information (step S209). The disk control apparatus 10 ends the processing.

Following the processing at step S204, when the I/O response acquiring unit 15 receives an I/O request response from the magnetic disk device 20 (“Yes” at step S205), the I/O response notifying unit 12 notifies the OS 5 of an I/O response (step S206). The disk control apparatus 10 ends the processing. On the other hand, when the I/O response acquiring unit 15 does not receive an I/O response (“No” at step S205), the state judging unit 13 issues a state check command to the magnetic disk device 20 (step S207) and judges whether a response indicating that a device state is normal is received (step S208).

When the state judging unit 13 receives a response indicating that a device state is normal (“Yes” at step S208), the disk control apparatus 10 proceeds to step S205 and waits for reception of an I/O response. On the other hand, when the state judging unit 13 does not receive a response indicating that a device state is normal from the magnetic disk device 20 (“No” at step S208), that is, when the state judging unit 13 receives a response indicating that a device state is abnormal or does not receive a response within a predetermined time, the I/O response notifying unit 12 notifies the OS 5 of error information (step S209). The disk control apparatus 10 ends the processing.

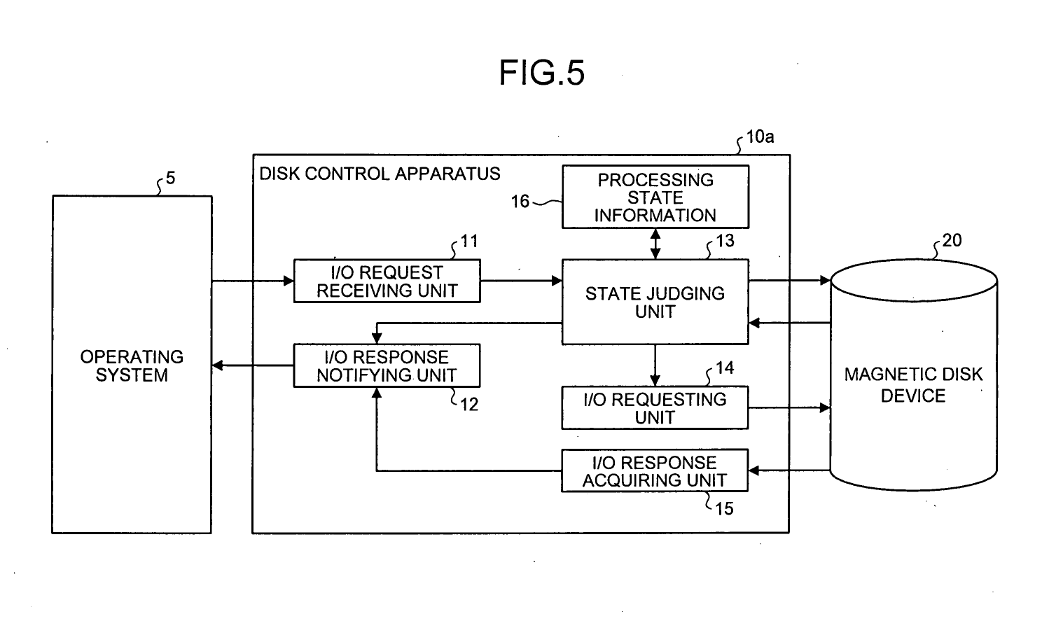

The disk control apparatus 10 in FIG. 2 acquires a device state of the magnetic disk device 20 with an I/O request from the OS 5 as a trigger. However, the present invention is not limited to this processing. It is also possible to receive a device state acquisition request from the OS 5 and send a device state as a response to the request. Thus, a disk control apparatus 10a having a device state response function is explained below. FIG. 5 is a block diagram of a constitution of the disk control apparatus 10a having the device state response function.

Differences between the disk control apparatus 10a and the disk control apparatus 10 shown in FIG. 2 are mainly explained below. Processing units that perform the same processing as those in FIG. 2 are denoted by the identical reference numerals. Explanations of the processing units are omitted. As shown in FIG. 5, the disk control apparatus 10a includes a storing unit that stores processing state information 16 in addition to the respective processing units (11 to 15) included in the disk control apparatus 10 (see FIG. 2).

The processing state information 16 is information that is updated by the state judging unit 13 and represents the progress of a state check command issued to the magnetic disk device 20. For example, such processing state information 16 is information including items like the number of times of issuance of a state check command and an elapsed time after the issuance.

The I/O request receiving unit 11 shown in FIG. 5 further performs processing for receiving a device state acquisition request in addition to an I/O request and passing the device state acquisition request received to the state judging unit 13. The state judging unit 13 further performs processing for acquiring information corresponding to the device state acquisition request from the processing state information 16 and sending the device state acquired to the OS 5 via the I/O response notifying unit 12.

If the disk control apparatus 10a has the device state response function in this way, the OS 5 is capable of acquiring a device state of the magnetic disk device 20 at desired timing. Therefore, the OS 5 or an application (see FIG. 1) can recognize a failure of the magnetic disk device 20 at an early stage.

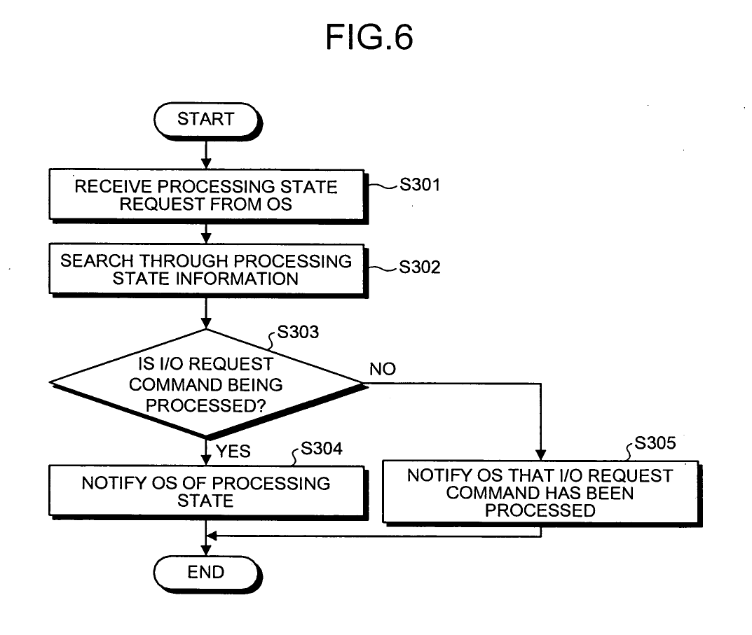

A processing procedure of processing state response processing executed in the disk control apparatus 10a shown in FIG. 5 is explained with reference to FIG. 6. FIG. 6 is a flowchart of the processing procedure of the processing state response processing. As shown in the figure, when the I/O request receiving unit 11 receives a processing state request from the OS 5 (step S301), the state judging unit 13 searches through the processing state information 16 (step S302).

When an I/O request command corresponding to the processing state request is being processed (“Yes” at step S303), the I/O response notifying unit 12 notifies the OS 5 of a processing state extracted from the processing state information 16 (step S304). The disk control apparatus 10a ends the processing. On the other hand, when an I/O request command corresponding to the processing state request has been processed (“No” at step S303), the I/O response notifying unit 12 notifies the OS 5 that the I/O request command has been processed (step S305). The disk control apparatus 10a ends the processing.

In FIG. 2, the disk control apparatus 10 is provided between the OS 5 and the magnetic disk device 20. However, it is also possible to distribute the respective processing units included in the disk control apparatus 10 on the computer 1 on which the OS 5 operates and the magnetic disk device 20.

In the following explanation of the respective processing units included in the disk control apparatus 10 shown in FIG. 2, the processing units are distributed on the computer 1 and the magnetic disk device 20. FIG. 7 is a block diagram of constitutions of a driver 10b and a magnetic disk device 20a. In FIG. 7, processing units that perform the same processing as those in FIG. 2 are denoted by the identical reference numerals. Explanations of the processing units are omitted.

As shown in FIG. 7, the driver 10b provided on the computer 1 includes the I/O request receiving unit 11 and the I/O response notifying unit 12. The magnetic disk device 20a includes the state judging unit 13, the I/O requesting unit 14, and the I/O response acquiring unit 15.

If the processing units such as the state judging unit 13 are provided in the magnetic disk device 20a in this way, it is possible to adopt an independent interface as an interface between the computer 1 and the magnetic disk device 20a. This makes it easy to provide a command with high processing efficiency and a command with high response speed anew and makes it possible to promptly acquire a failure state of the magnetic disk device 20.

In the explanation with reference to FIG. 2, the disk control apparatus 10 performs input/output control for the single magnetic disk device 20. However, the disk control apparatus 10 can also perform input/output control for a disk array apparatus including a plurality of magnetic disk devices. In performing the input/output control for the disk array apparatus, when a failure of a specific magnetic disk device is detected, it is possible to continue the input/output control using a normal magnetic disk device as a substitute device. A disk control apparatus 10c having a substitution processing function is explained below.

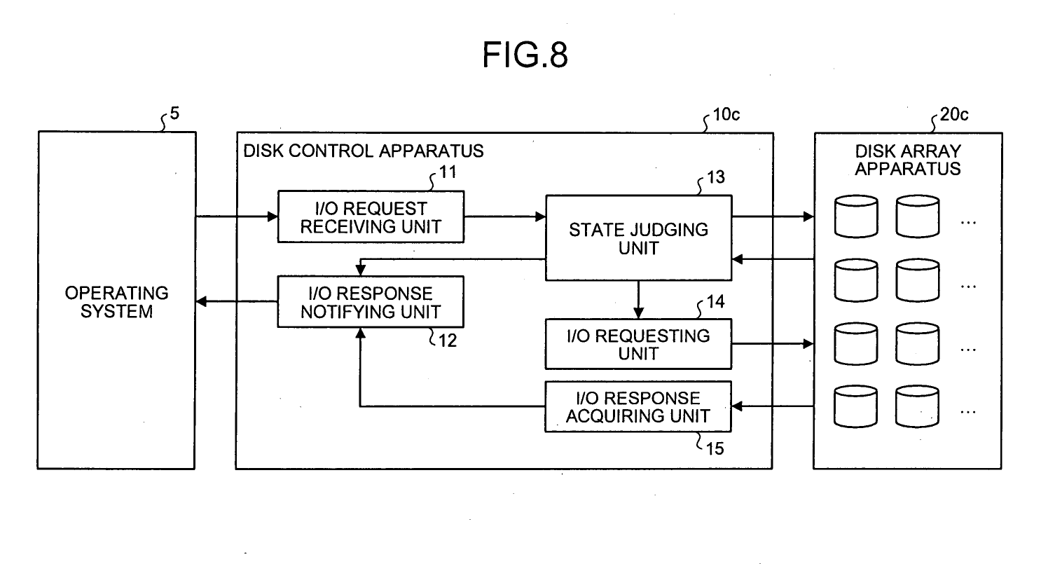

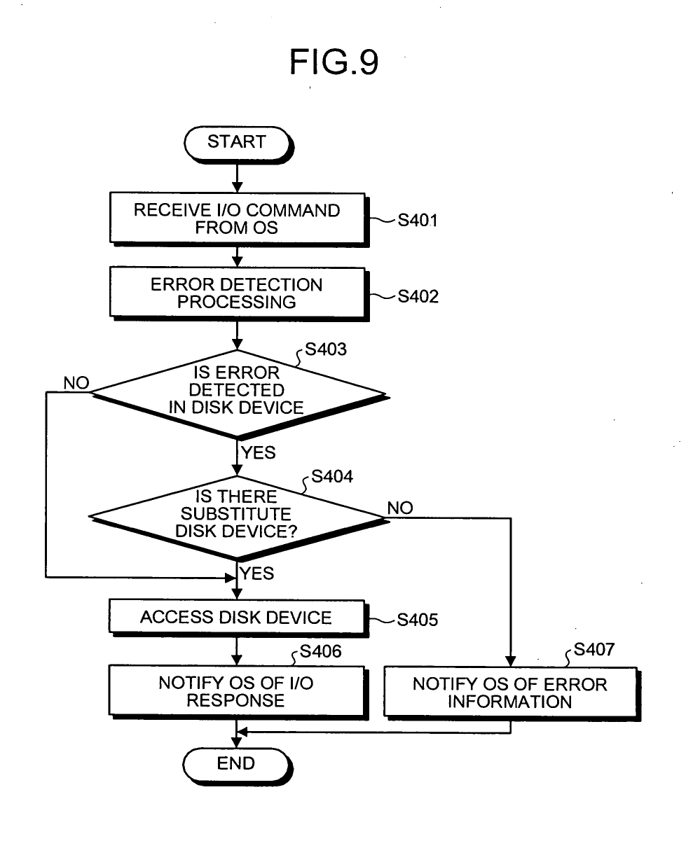

FIG. 8 is a block diagram of a constitution of the disk control apparatus 10c including the substitution processing function. As shown in the figure, the disk control apparatus 10c includes the respective processing units (11 to 15) that are the same as those in the disk control apparatus 10 (see FIG. 2). The state judging unit 13 of the disk control apparatus 10c is different from that of the disk control apparatus 10 in that the state judging unit 13 of the disk control apparatus 10c has the substitution processing function for a magnetic disk device to which an I/O request is issued. A processing procedure of substitution processing performed by the state judging unit 13 shown in FIG. 8 is explained with reference to FIG. 9. FIG. 9 is a flowchart of the processing procedure of the substitution processing.

As shown in FIG. 9, when the I/O request receiving unit 11 receives an I/O request (an I/O command) from the OS 5 (step S401), the disk control apparatus 10c executes the error detection processing shown in FIG. 3 for a magnetic disk device to which the I/O request is issued (step S402). Subsequently, when the disk control apparatus 10c detects an error in the magnetic disk device (“Yes” at step S403), the disk control apparatus 10c judges whether there is a substitute disk device (step S404).

When there is a substitute disk device (“Yes” at step S404), the disk control apparatus 10c accesses this disk device (the substitute disk device) (step S405). On the other hand, when the disk control apparatus 10c does not detect an error of the disk device at step S403 (“No” at step S403), the disk control apparatus 10c accesses the disk device (step S405).

Following step S405, the I/O response notifying unit 12 notifies the OS 5 of an I/O response (step S406). The disk control apparatus 10c ends the processing. On the other hand, when it is judged at step S404 that there is no substitute disk device (“No” at step S404), the I/O response notifying unit 12 notifies the OS 5 of error information (step S407). The disk control apparatus 10c ends the processing.

As described above, in the device control apparatus, the state judging unit, to which an I/O request received by the I/O request receiving unit is passed, acquires a device state by issuing a state check command to a control command queue of the magnetic disk device. When the device state acquired is normal, the I/O requesting unit issues an I/O command to the I/O command queue of the magnetic disk device. When the device state acquired is not normal, the I/O response notifying unit notifies a request source of the I/O request of error information of the device state. This makes it possible to detect an error of the magnetic disk device at an early stage.

According to one aspect, a device state of the magnetic disk device is acquired by issuing a device state inquiry command to the control command queue and judged. On condition that the device state of the magnetic disk device is judged as normal, a data input/output command is issued to the data input/output command queue. On condition that the device state of the magnetic disk device is judged as not normal, an error of the magnetic disk device is informed. Thus, even when an unrecoverable failure occurs in the magnetic disk device, it is possible to detect the error of the magnetic disk device at an early stage.

Moreover, according to another aspect, after the data input/output command is issued, a device state of the magnetic disk device is acquired by issuing a device state inquiry command to the control command queue at each predetermined interval. After the data input/output command is issued, an error of the magnetic disk device is informed on condition that the device state is judged as not normal. Thus, even when the magnetic disk device fails after the issuance of the data input/output command, it is possible to detect the error of the magnetic disk device at an early stage.

Furthermore, according to still another aspect, the device state acquired is informed in response to an inquiry from the outside. Thus, an operating system and an application operating on the operating system can acquire error information of the magnetic disk device at desired timing.

Moreover, according to still another aspect, after a data input/output command is issued to the data input/output command queue, a device state of the magnetic disk device is acquired by issuing a device state inquiry command to the control command queue at each predetermined interval and judged. On condition that the device state of the magnetic disk device is judged as not normal, an error of the magnetic disk device is informed. Thus, even when an unrecoverable failure occurs in the magnetic disk device after the issuance of the data input/output command, it is possible to detect the error of the magnetic disk device at an early stage.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An input/output control method for a magnetic disk device that includes a data command queue of data input/output commands and a control command queue of control commands, the input/output control method comprising:
issuing an inquiry command to the control command queue;
receiving state information indicative of a state of the magnetic disk device in response to the inquiry command;
judging whether the magnetic disk device is in a normal state based on the state information;
issuing a data input/output command to the data command queue when it is judged at the judging that the magnetic disk device is in the normal state; and
outputting error information indicative of a faulty magnetic disk device when it is judged at the judging that the magnetic disk device is not in the normal state.

2. The input/output control method according to claim 1, wherein
the issuing includes issuing the inquiry command repeatedly at a predetermined interval;
the receiving includes receiving state information in response to each of the inquiry commands;
the judging includes judging whether the magnetic disk device is in the normal state based on each of the state information; and
the outputting includes outputting error information indicative of faulty magnetic disk device when it is judged at the judging that the magnetic disk device is not in the normal state.

3. The input/output control method according to claim 1, further comprising outputting the state information received at the receiving to an external device in response to an inquiry from the external device.

4. The input/output control method according to claim 1, further comprising:
fatal error judging that the magnetic disk device has a fatal error when no state information is received at the receiving from the magnetic disk device within a predetermined time.

5. The input/output control method according to claim 2, further comprising:
fatal error judging that the magnetic disk device has a fatal error when it is judged at the judging that a predetermined number of consecutive state information indicate that the magnetic disk device is not normal.

6. The input/output control method according to claim 1, further comprising:
issuing the data input/output command to a data command queue of another magnetic disk device when it is judged at the judging that the magnetic disk device is not in the normal state.

7. An input/output control method for a magnetic disk device that includes a data command queue of data input/output commands and a control command queue of control commands, the input/output control method comprising:
data command issuing including issuing a data input/output command to the data input/output command queue;
inquiry command issuing including issuing an inquiry command at a predetermined interval from issuance of the data input/output command at the data command issuing;
receiving state information indicative of a state of the magnetic disk device in response to each of the inquiry command issued at the inquiry command issuing;
judging whether the magnetic disk device is in a normal state based on each of the state information received at the receiving; and
outputting error information indicative of a faulty magnetic disk device when it is judged at the judging that the magnetic disk device is not in the normal state.

8. A computer-readable recording medium that stores therein a computer program that causes a computer to perform input/output control in a magnetic disk device that includes a data command queue of data input/output commands and a control command queue of control commands, the computer program causing the computer to execute:
issuing an inquiry command to the control command queue;
receiving state information indicative of a state of the magnetic disk device in response to the inquiry command;
judging whether the magnetic disk device is in a normal state based on the state information;
issuing a data input/output command to the data command queue when it is judged at the judging that the magnetic disk device is in the normal state; and
outputting error information indicative of a faulty magnetic disk device when it is judged at the judging that the magnetic disk device is not in the normal state.

9. A disk control apparatus for performing input/output control on a magnetic disk device that includes a data command queue of data input/output commands and a control command queue of control commands, the disk control apparatus comprising:
a receiving unit that issues an inquiry command to the control command queue and receives state information indicative of a state of the magnetic disk device in response to the inquiry command;
a judging unit that judging whether the magnetic disk device is in a normal state based on the state information received by the receiving unit;
an issuing unit that issues a data input/output command to the data command queue when it is judged by the judging unit that the magnetic disk device is in the normal state; and
an outputting unit that outputting error information indicative of a faulty magnetic disk device when it is judged by the judging unit that the magnetic disk device is not in the normal state.
